(19) United States
(12) Patent Application Publication
(10) Pub. No.: US 2012/0330475 A1
(43) Pub. Date: Dec. 27, 2012

(54) Active Cloud Power Management System for a Secondary Battery

(76) Inventor: Fu-Chieh Chen, Taichung (TW)

(21) Appl. No.: 13/602,205

(22) Filed: Sep. 3, 2012

(30) Foreign Application Priority Data
May 23, 2011 (TW) 101209830
Aug. 9, 2011 (TW) 101128779

(51) Int. Cl. G05F 5/00

(52) U.S. Cl. 700/292

(57) ABSTRACT

The present invention discloses an active cloud power management system for a secondary battery. This power management system is able to actively handle electrical properties of the secondary battery and provide a user with a general status message or a real time early warning message about the secondary battery, so that an efficiency of use and safety of the secondary battery can be maintained by active monitoring and reminding services.

### BACKGROUND OF THE INVENTION

a) Field of the Invention

The present invention relates to a secondary battery management plan, and more particularly to a management system that through a cloud management system, electrical properties of a secondary battery are controlled and a general status message or a real time early warning message of that secondary battery is provided to a user, so that the efficiency of use and the safety of the secondary battery can be maintained by active monitoring and reminding services.

b) Description of the Prior Art

A battery management system that is equipped with a starter battery of an ordinary vehicle or a device that is provided with a battery, e.g., an UPS (Uninterruptible Power Supply), is mostly responsible for monitoring charging and discharging of the battery. Information provided to a user of the vehicle or the device, therefore, is only limited to the surplus capacity of the battery and the low battery warning that are displayed on a dashboard or display instrument. Accordingly, the status of the battery that the user is aware of is rather crude; the type of battery, the manufacturer, the factory time, the remainder of the warranty period, the electrical properties (such as the number of connections in series, the total voltage, the string voltage, the temperature, the number of times of battery charging and discharging), the relationship between the speed of the vehicle and the battery status, as well as when to carry out the scheduled maintenance is unavailable. Hence, only when the vehicle or the device immobilizes due to malfunction of the battery, or when a shipping kilometer is shortened, a ruffling occurs in traveling, a horsepower is not sufficient, the vehicle dashes or even an engine fails to start as the battery status is inferior that the user can find out that the battery is in trouble and then send the battery for repairing. However, what the vendor will do is to replace the troubled battery with a new or second-hand battery.

The main reason resulting in the abovementioned problems is a lack of active management role and mechanism between the vendor and the user.

### SUMMARY OF THE INVENTION

The primary object of the present invention is to provide an active cloud power management system for a secondary battery, including a cloud server management module, a user end management module that is installed on a user's smart mobile device, and a circuit monitoring module that is installed on a vehicle or a device that is provided with a battery to collect electrical properties of the secondary battery. Through the cloud server management module, the electrical properties of the secondary battery are controlled and a general status message or a real time early warning message of the secondary battery is provide to the user, so that the efficiency of use and safety of the secondary battery can be maintained by active monitoring and reminding services.

In the present invention, the user end management module is loaded on the user's smart mobile device and the circuit monitoring module is installed on the vehicle or the device that is provided with the secondary battery to collect the electrical properties of the secondary battery. In addition, packets are uploaded at a fixed time to the cloud server management module. The cloud server management module matches, compares and analyzes the received electrical properties with the battery data stored in a database and converts the results of comparison and analysis into a general status message or a real time early warning message. The general status message is transmitted at a fixed time to the user end management module, allowing the user to be aware of the most updated electrical properties through the user end management module. On the other hand, the real time early warning message is transmitted in real time to the user end management module where the user can get the real time warning to response and cope with the situation accordingly.

The primary technologies include a cloud server management module, at least a user end management module that is installed on the user's smart mobile device and at least a circuit monitoring module that is installed on the vehicle or the device that is provided with the secondary battery to collect the electrical properties of the secondary battery. The cloud server management module and the user end management module are equipped with networking and mobile transmission functions to transmit and receive data to and from each other. The circuit monitoring module monitors the electrical properties of the secondary battery and transmits the electrical properties to the user end management module wirelessly; whereas, the user end management module uploads the received electrical properties to the cloud server management module. The cloud server management module receives, processes, and stores the real time electrical properties that are transmitted from the user end management module, as well as compares the real time electrical properties with defaults. If the results of comparison are within a tolerable level of the defaults, a general status message is formed. On the other hand, if the results of comparison are not within the tolerable level, a real time early warning message is formed. The cloud server management module transmits the general status message to the user end management module at a fixed time, and transmits the real time early warning message to the user end management module in real time.

To enable a further understanding of the objectives and the technological methods of the invention herein, the brief description of the drawings below is followed by the detailed description of the preferred embodiments.

### BRIEF DESCRIPTION OF THE DRAWINGS

FIG. 1 shows a schematic view of connections among a cloud server management module, a user end management module and a circuit monitoring module, according to the present invention, and

FIG. 2 shows a block diagram of the cloud server management module, the user end management module and the circuit monitoring module, according to the present invention.

### DETAILED DESCRIPTION OF THE PREFERRED EMBODIMENTS

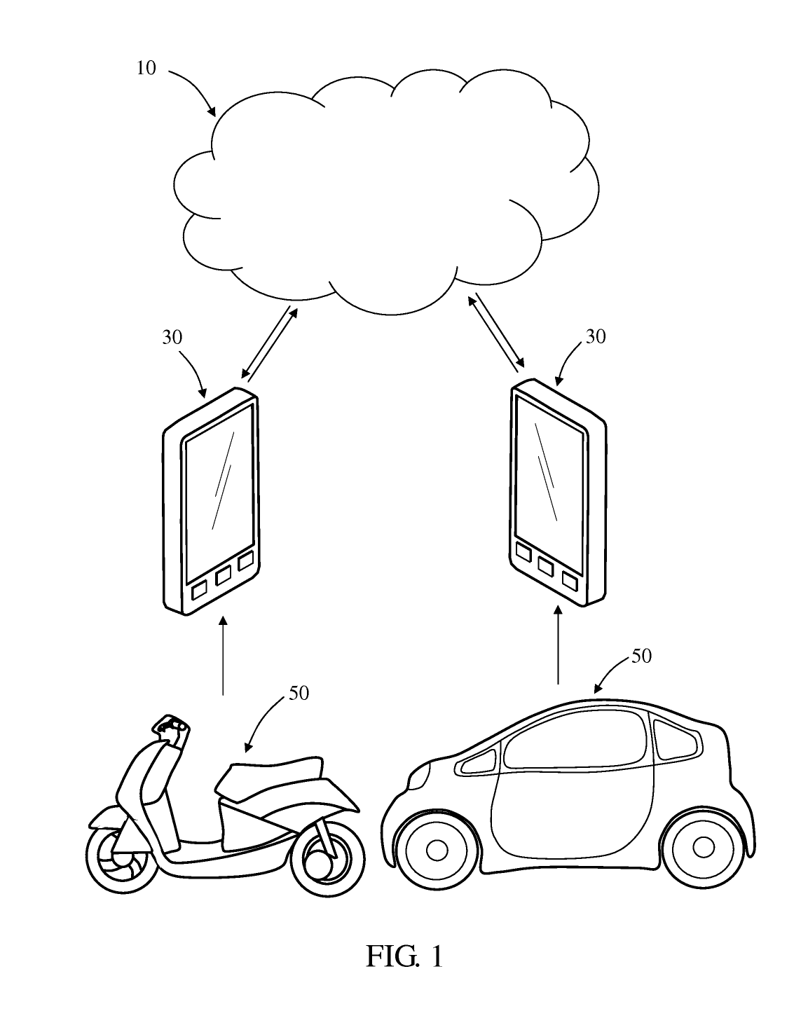

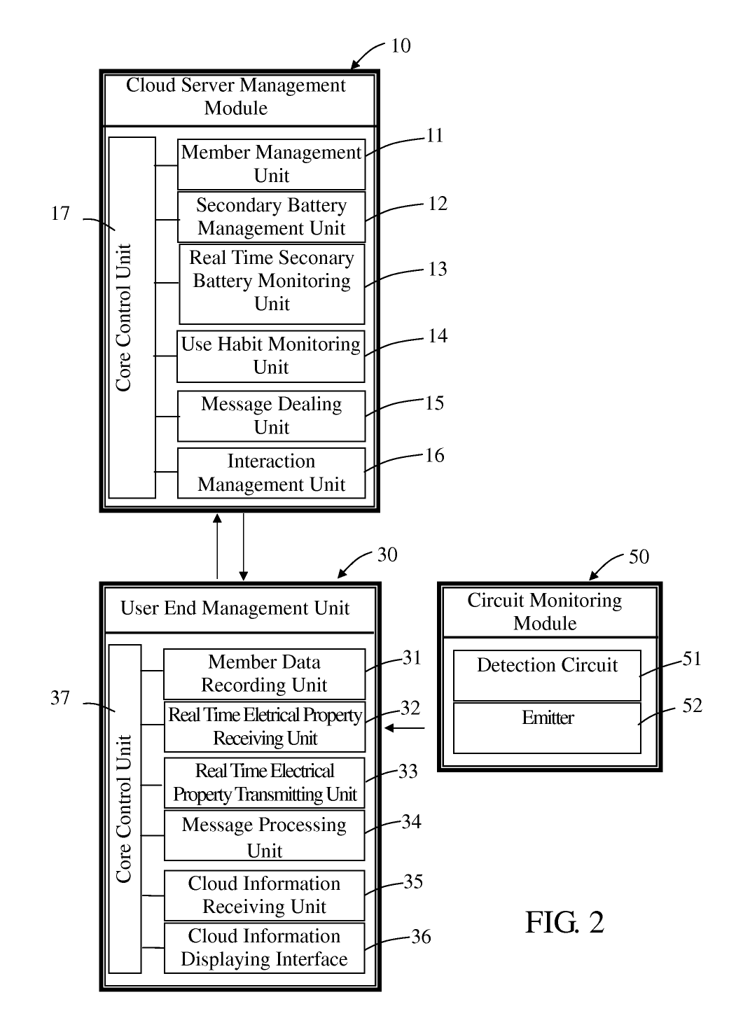

Referring to FIG. 1 and FIG. 2, an active cloud power management system for a secondary battery of the present invention, comprises a cloud server management module 10, a user end management module 30 that is installed on a user's smart mobile device, and a circuit monitoring module 50 that is installed on a vehicle or a device that is provided with a secondary battery to collect electrical properties of the secondary battery. The cloud server management module 10 and the user end management module 30 are equipped with networking and mobile transmission functions to execute data transmission and receiving. The networking and mobile transmission functions include, but not limited to, internet, LAN (Local Area Network), WAN (Wide Area Network), wireless, WiFi, WiMAX, and transmission protocols of the 3G, 3.5G, or 4G mobile communications. The circuit monitoring module 50 transmits signals to the user end management module 30 through wireless transmission (such as Bluetooth).

The cloud server management module 10 includes: a member management unit 11, the member management unit 11 is used to receive, process and store member data transmitted from the user end management module 30; a secondary battery management unit 12, the secondary battery management unit 12 is used to receive, process and store basic data and defaults of electrical properties of the secondary battery provided by a battery manufacturer, wherein the basic data include, but not limited to, the factory time of the secondary battery, the type of the secondary battery, the serial number of the secondary battery, and the number of connections in series, whereas the defaults of the electrical properties include, but not limited to, the rated capacity, the rated current, the rated total voltage, the rated string voltage and the allowable number of times of battery charging and discharging, the defaults of the electrical properties being provided to match with the basic data; a real time secondary battery monitoring unit 13, the real time secondary battery monitoring unit 13 is used to receive, process and store the real time electrical properties transmitted from the user end management module 30, as well as compare the real time electrical properties with the defaults of the electrical properties of the secondary battery management unit 12, where if the results of comparison are within a tolerable level of the defaults, a general status message will be formed, and if the results of comparison are not within the tolerable level, a real time early warning message will be formed, the general status message including, but not limited to, the surplus capacity of the secondary battery, the number of times of battery charging and discharging, the speed of the vehicle, the current, the total voltage, the string voltage, the battery temperature, the remainder of the warranty period and the time for reminding of the scheduled maintenance, whereas the real time early warning message including, but not limited to, that the surplus capacity of the secondary battery is below a safety level, the current is abnormal, the voltage is abnormal, the temperature is abnormal, and the battery is discharging abnormally; a use habit monitoring unit 14, the use habit monitoring unit 14 is used to receive and record the date and time that the user end management module 30 connects on-line to upload the real time electrical properties, as well as tally the number of consecutive days that the user end management module 30 has not connected on-line to upload the electrical properties since the next day following the last upload, where if the number of consecutive days exceeds a defined default, a use habit early warning message will be formed by the use habit monitoring unit 14; a message dealing unit 15, the message dealing unit 15 is used to receive, process and store the general status message, the real time early warning message and the use habit early warning message described above, and transmit these messages to the corresponding user end management module 30; an interaction management unit 16, the interaction management unit 16 is used to receive, process and store text messages or voice messages that are transmitted from the user end management module 30, and deliver the text messages or the voice messages to a secondary battery manufacturer or distributor for response; and a core control unit 17, the core control unit 17 is used to command, control, order and manage the operation of the abovementioned units of the cloud server management module 10.

The user end management module 30 includes: a member data recording unit 31, the member data recording unit 31 is used to receive and process the basic member data inputted from the user's smart mobile phone, and upload the basic member data to the member management unit 11 of the cloud server management module 10 for storage, wherein the basic member data include, but not limited to, the account number, the password, the contact number, the information of the vehicle used (brand, year, model and CC), and the serial number of the secondary battery that can be inputted with QRCode or by an ordinary method, where after the member management unit of the cloud server management module has received the serial number of the secondary battery, that serial number is automatically matched with the basic data and the defaults of the electrical properties of the secondary battery in the secondary battery management unit, in order to get the factory time, type, serial number, number of connections in series, rated capacity, rated current, rated total voltage, rated string voltage and number of times of battery charging and recharging, corresponding to that serial number of the secondary battery; a real time electrical property receiving unit 32, the real time electrical property receiving unit 32 is used to receive and store the real time electrical properties of the secondary battery transmitted every second from the circuit monitoring module 50 in real time, wherein the real time electrical properties include, but not limited to, the surplus capacity of the battery, the number of times of battery charging and discharging, the speed of the vehicle, the total voltage of battery, the current, the string voltage and the battery temperature; a fixed time electrical property transmitting unit 33, the fixed time electrical property transmitting unit 33 is used to upload the real time electrical properties stored by the real time electrical property receiving unit 32 in packets and at a fixed time (e.g. every 10 minutes) to the real time secondary battery monitoring unit 13 of the cloud server management module 10; a message processing unit 34, the message processing unit 34 is used to receive and process text messages or voice messages inputted from the user's smart mobile device, as well as upload the messages to the interaction management unit 16 of the cloud server management module 10; a cloud information receiving unit 35, the cloud information receiving unit 35 is used to receive and store the general status message, the real time early warning message, the use habit early warning message as well as the response message transmitted by the message dealing unit 15 and the interaction management unit 16 of the cloud server management module 10; a cloud information display interface 36, the cloud information display interface 36 is used to display the message processed by the cloud information receiving unit 35 in a graphical interface for access by the user; and a core control unit 37, the core control unit 37 is used to command, control, order and manage the operation of the abovementioned units of the user end management module 30.

The circuit monitoring module 50 includes: a detection circuit 51, the detection circuit 51 is connected electrically with the secondary battery system to get the real time electrical properties of the secondary battery system every second, wherein the real time electrical properties include, but not limited to, the surplus capacity of the battery, the number of times of battery charging and discharging, the speed of the vehicle, the total voltage of the battery, the current of the battery, the string voltage of the battery and the temperature of the battery; and an emitter 52, the emitter 52 is connected electrically with the detection circuit 51 to transmit the acquired real time electrical properties to the real time electrical property receiving unit 32 of the user end management module 30.

Furthermore, the collaborative operation of the cloud server management module 10, the user end management module 30 and the circuit monitoring module 50 are described as follows.

Through the member data recording unit 31 of the user end management module 30, the user registers to the cloud server management module 10 as a member. The member management unit 11 of the cloud server management module 10 further matches and links the serial number of the secondary battery transmitted by the member with the basic data and the defaults of the electrical properties of the secondary battery in the secondary battery management unit 12.

When the member starts a vehicle or a device that is provided with the secondary battery and turns on the user end management module 30 of his or her smart mobile device such as a smart cell phone, the detection circuit 51 of the circuit monitoring module will get every second the real time electrical properties of the secondary battery system and transmit to the real time electrical property receiving unit 32 of the user end management module 30 through the emitter. The real time electrical property receiving unit will store the acquired real time electrical properties every second and then, upload the stored real time electrical properties per second in packets and at a fixed time (e.g., every 10 minutes) to the real time secondary battery monitoring unit 13 of the cloud server management module 10, through the real time electrical property transmitting unit 33. The real time secondary battery monitoring unit 13 will then compare in real time the real time electrical properties with the defaults of the electrical properties of the secondary battery management unit 12. If the results of comparison are within a tolerable level of the defaults, a general status message is formed; on the other hand, if the results of comparison are not within the tolerable level of the defaults, a real time early warning message is formed.

The message dealing unit 15 transmits at a fixed time the general status message to the cloud information receiving unit 35 of that member's user end management module 30, and then displays the general status message on the member's smart mobile device for access through the cloud information display interface 36, so that the user can be aware of the current status of the secondary battery. On the other hand, the message dealing unit 15 transmits in real time the real time early warning message to the cloud information unit 35 of that member's user end management module 30 and then displays the real time early warning message on that member's smart mobile device for real time access through that cloud information display interface 36. The active push of the real time early warning message allows the user to be aware of in real time when an abnormal warning message of the secondary battery appears, enabling the user to respond actively (e.g., charging the battery or sending the battery to the vendor for maintenance earlier than a scheduled time), without sending the battery passively for replacement until that the secondary battery is out of battery or is damaged. When the user responds actively by sending the secondary battery to the vendor for maintenance earlier than the scheduled time, the real time early warning message displayed by the cloud information display interface 36 can be provided to a maintenance crew, so that the maintenance crew can be aware of the problems of the secondary battery.

Besides, the use habit monitoring unit 14 of the cloud server management module 10 will tally the number of consecutive days that the user end management module 30 has not connected to upload data since the next day following the last connection and upload of the user end management module 30. If the number of consecutive days exceeds a defined default (e.g., 10 days), the use habit monitoring unit 14 will form a use habit early warning message and hand it over to the message dealing unit 15 to transmit to the cloud information receiving unit 35 of that member's user end management module 30. Through the display by the cloud information display interface 36, the member is reminded of that it has been a period of time since the secondary battery data has not been uploaded on-line.

Accordingly, the active cloud power management system for a secondary battery of the present invention handles the electrical properties of the secondary battery and provides the user with the general status message or the real time early warning message about the secondary battery, so that the efficiency of use and safety of the secondary battery can be maintained by active monitoring and reminding services. The circuit monitoring module 50 can be installed on a starter battery and its circuit system of a fuel-powered motorcycle or car, a battery and its circuit system of an electric motorcycle or car, or a battery and its circuit system of an UPS. Therefore, the active cloud power management system for a secondary battery of the present invention can be fitted with any equipment or device that is installed with a secondary battery.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An active cloud power management system for a secondary battery, comprising a cloud server management module, at least a user end management module that is installed on a user's smart mobile device, and at least a circuit monitoring module that is used to collect electrical properties of the secondary battery, wherein the cloud server management module and the user end management module are equipped with networking and mobile transmission functions to transmit and receive data to and from each other, whereas the circuit monitoring module transmits the electrical properties to the user end management module wirelessly;
the cloud server management module including:
a secondary battery management unit, the secondary battery management unit is used to receive, process and store the basic data and defaults of electrical properties of the secondary battery, provided by a secondary battery manufacturer;
a real time secondary battery monitoring unit, the real time secondary battery monitoring unit is used to receive, process and store the real time electrical properties transmitted from the user end management module, as well as compare the real time electrical properties with the defaults of the electrical properties in the secondary battery management unit, with that if the results of comparison are within a tolerable level of the defaults, a general status message is formed, whereas if the results of comparison are not within the tolerable level of the defaults, a real time early warning message is formed;
a message dealing unit, the message dealing unit is used to receive, process and store the abovementioned general status message and real time early warning message, and transmit the messages to the corresponding user end management module; and
a core control unit, the core control unit is used to command, control, order and manage the operation of all units of the cloud server management module.

2. The active cloud power management system for a secondary battery according to claim 1, wherein the user end management module includes:
a real time electrical property receiving unit, the real time electrical property receiving unit is used to receive and store the real time electrical properties of the secondary battery transmitted in real time from the circuit monitoring module;
a fixed time electrical property transmitting unit, the fixed time electrical property transmitting unit is used to upload at a fixed time the real time electrical properties stored by the real time electrical property receiving unit to the real time secondary battery monitoring unit of the cloud server management module;
a cloud information receiving unit, the cloud information receiving unit is used to receive and store the general status message and the real time early warning message transmitted from the message dealing unit of the cloud server management module;
a cloud information display interface, the cloud information display interface is used to display the messages processed by the cloud information receiving unit; and
a core control unit, the core control unit is used to command, control, order and manage the operation of all units of the user end management module.

3. The active cloud power management system for a secondary battery according to claim 2, wherein the real time electrical property receiving unit of the user end management module receives and stores in real time the real time electrical properties of the secondary battery transmitted per second from the circuit monitoring module and the real time electrical properties include the surplus capacity of battery, the number of times of battery charging and discharging, the speed of the vehicle, the total voltage of the battery, the current, the string voltage and the temperature of the battery.

4. The active cloud power management system for a secondary battery according to claim 2, wherein the circuit monitoring module includes:
a detection circuit, the detection circuit is connected electrically with the secondary battery to acquire the real time electrical properties of the secondary battery; and
an emitter, the emitter is connected with the detection circuit to transmit the real time electrical properties acquired by the detection circuit to the real time electrical property receiving unit of the user end management module.

5. The active cloud power management system for a secondary battery according to claim 1, wherein the cloud server management module further includes a member manage unit to receive, process and store member data transmitted from the user end management module.

6. The active cloud power management system for a secondary battery according to claim 5, wherein the user end management module further includes a member data recording unit to receive and process basic member data and the serial number of the secondary battery inputted from a user's smart mobile device.

7. The active cloud power management system for a secondary battery according to claim 1, wherein the cloud server management module further includes a use habit monitoring unit to receive and record the number of consecutive days that the user end management module has not connected to upload the real time electrical properties, with that if the number of consecutive days exceeds a defined default, a use habit early warning message is formed by the use habit monitoring unit and the use habit early warning message is transmitted to the user end management module through the message dealing unit.

8. The active cloud power management system for a secondary battery according to claim 1, wherein the secondary battery management unit receives, processes and stores the basic data of the secondary battery, including the factory time of the secondary battery, the type of the secondary battery, the serial number of the secondary battery and the number of connections in series, whereas the secondary battery management unit receives, processes and stores defaults of the electrical properties, including the rated capacity, the rated current, the rated total voltage, the rated string voltage and the number of times of battery charging and discharging.

9. The active cloud power management system for a secondary battery according to claim 1, wherein the general status message includes the surplus capacity of the battery, the number of times of battery charging and discharging, the speed of the vehicle, the current, the total voltage, the string voltage, the battery temperature, the remainder of the warranty period, and the time for reminding of a scheduled maintenance, whereas the real time early warning message includes that the surplus capacity of the battery is below a safety level, the current is abnormal, the voltage is abnormal, the temperature is abnormal and the battery is discharging abnormally.

10. The active cloud power management system for a secondary battery according to claim 1, wherein the cloud server management module further includes an interaction management unit, and the user end management module further includes a message processing unit, with that the message processing unit receives and processes text messages or voice messages inputted from the user's smart mobile device, as well as uploads the messages to the interaction management unit.
